(19) United States
(12) Patent Application Publication
(10) Pub. No.: US 2020/0134734 A1
(43) Pub. Date: Apr. 30, 2020

(54) DEEP LEARNING ARTIFICIAL INTELLIGENCE FOR OBJECT CLASSIFICATION

(71) Applicant: Cover Financial, Inc., San Francisco, CA (US)

(72) Inventor: Ben Aneesh, San Francisco, CA (US)

(21) Appl. No.: 16/666,357

(22) Filed: Oct. 28, 2019

Related U.S. Application Data
(60) Provisional application No. 62/751,531, filed on Oct. 26, 2018.

(51) Int. Cl. G06Q 40/08; G06N 3/08; G06N 3/04; G06F 16/28; G06Q 30/02; G06Q 10/10; G06K 9/62

(52) U.S. Cl. CPC G06Q 40/08; G06N 3/08; G06N 3/04; G06F 16/285; G06K 9/00744; G06Q 10/10; G06K 9/6268; G06K 9/6256; G06Q 30/0278

(57) ABSTRACT

Methods and system for cataloging items and classifying items are disclosed. In some embodiments, a mobile computing device may be used to capture an image of an item. The item may be identified and classified by the mobile computing device based on the image of the item. A location of the mobile computing device may be determined and associated with the image of the item.

### CROSS-REFERENCE TO RELATED APPLICATIONS

This application claims the benefit of U.S. Provisional Patent Application No. 62/751,531, filed Oct. 26, 2018, which is hereby incorporated by reference in its entirety.

### BACKGROUND

Neural networks, and specifically convolutional neural networks may be used for image recognition tasks. For example, neural networks may be used to identify and classify objects that appear in images. Recent advances in neural network design, notably deeper models with more layers enabled by the availability of cheap computing power and enhanced techniques such as inception modules and skip connections, have created models that rival human accuracy in object identification.

Insurance may be purchased for various goods or items. For example, homeowner's insurance may be purchased to protect a home and items within the home. Similarly, renter's insurance may be purchased to protect items within a rental property.

### SUMMARY

According to one implementation, this specification describes systems and methods to automate cataloging of items using artificial intelligence. For example, a mobile computing device may capture images of items. The images may be evaluated to identify and classify items that may be insurable. A value may be estimated based on the identity and classification of each item. The images of items and their estimated values may be used for underwriting insurance for those items. Then, if any claims arise for the items, the images and other information gathered during underwriting may be used to assess the validity of those claims during claims processing.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

The present disclosure will become more fully understood from the detailed description and the accompanying drawings, wherein:

FIG. 1 illustrates a method of cataloging items according to an embodiment;

FIGS. 2A-2B illustrate a method of cataloging items according to an embodiment;

FIG. 3 illustrates an example computing environment according to an embodiment;

FIGS. 4A-4E illustrate a method of cataloging items according to an embodiment;

FIG. 5 illustrates the steps of a method for claims processing according to an embodiment; and

FIG. 6 illustrates an example machine of a computer system within which a set of instructions, for causing the machine to perform any one or more of the methodologies discussed herein, may be executed.

### DETAILED DESCRIPTION

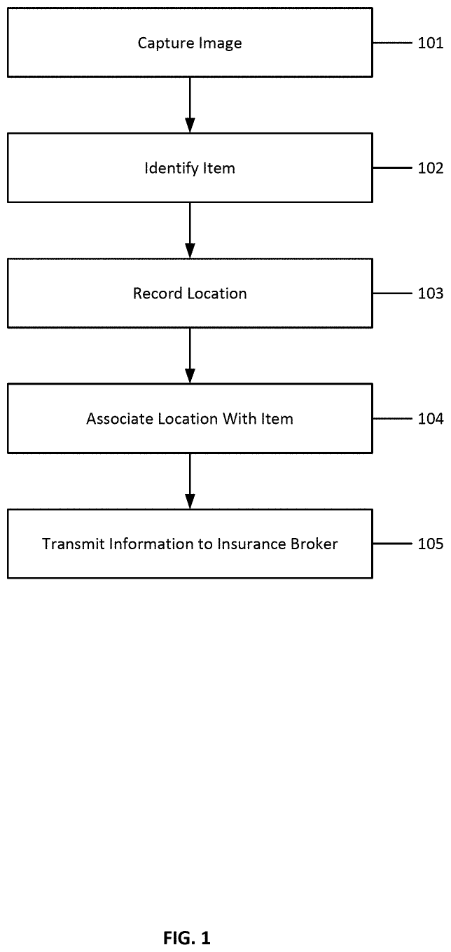

FIG. 1 illustrates a method of cataloging items according to an embodiment. At step 101, an image is captured by a mobile computing device that depicts an insurable item. At step 102, the item depicted within the image is identified and classified by the mobile computing device. At step 103, a location of the mobile computing device is determined, and at step 104, the location associated with the image and classification of the item. At step 105, the mobile computing device transmits the image of the insurable item, the category of the insurable item, and the location of the mobile computing device to an insurance underwriting system. Upon receipt, the insurance underwriting system in turn uses the received information to determine a parameter of an insurance policy based at least in part on the received information.

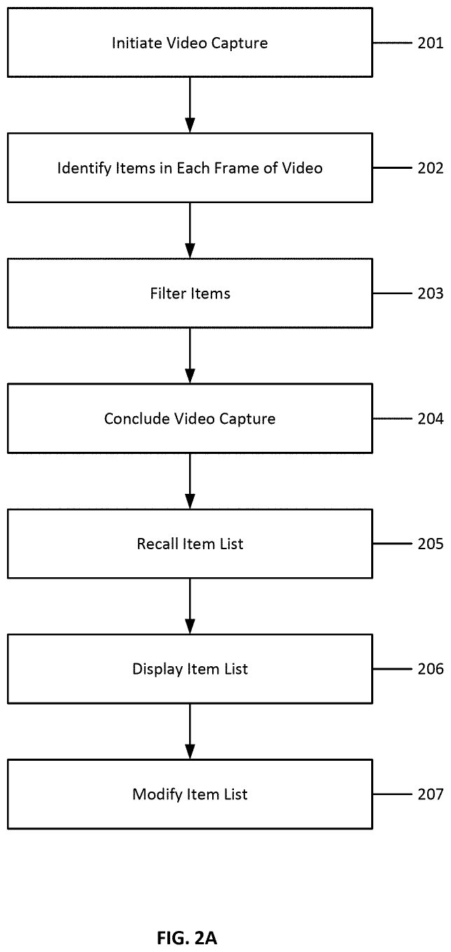

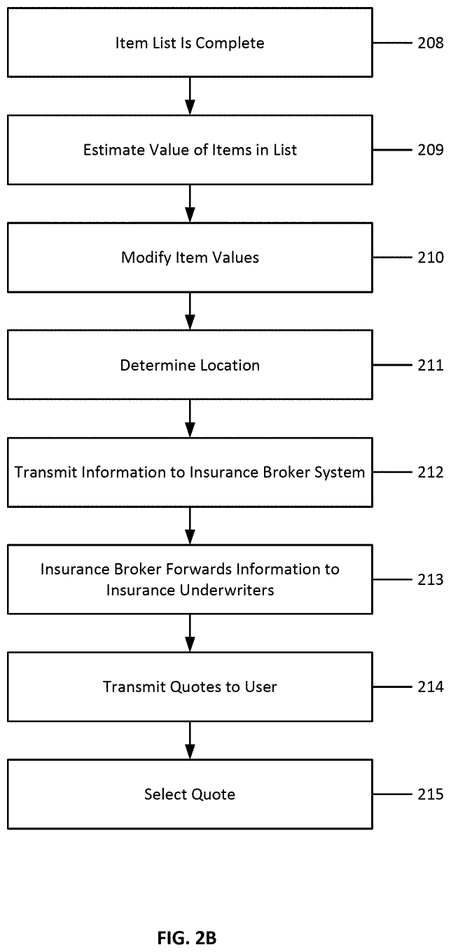

FIGS. 2A-2B illustrate a method of cataloging items according to an embodiment. In some examples, the items may be household items such as appliances, electronics, or other valuables that may be covered by an insurance policy. In some examples, items may be items used in a commercial setting such as fixtures, machinery, inventory, or other such items that may be covered by an insurance policy. At step 201, a mobile computing device such as a smartphone device initiates capture of a video of items. In some embodiments, different mobile computing devices may be used to capture video, such as but not limited to digital cameras, tablet computers, personal digital assistants, laptop computers, or other such mobile computing devices capable of capturing video. Items may include, for example, household appliances such as refrigerators, jewelry, electronics or computing equipment, or other such items of value that may be insured by an insurance policy.

At step 202, each frame of the video is processed to identify potential items of interest. In some embodiments, potential items may be identified by an image segmentation process that segments items depicted in a frame of video. For example, a refrigerator may be one such item that is identified and segmented from a frame of video. In some embodiments, an entire frame may be passed on to the following steps with the assumption that only one item is pictured in a frame at a time.

In some embodiments, a frame of video is processed with a neural network classifier to identify and classify items. The neural network may be comprised of a plurality of layers including one or more convolutional neural network (CNN) layers. For example, a trained convolutional neural network may identify the location of multiple objects or items within a frame of video and classify those objects. In some embodiments, a neural network may be implemented using technologies such as TENSORFLOW. In some embodiments, a neural network classifier may be implemented on the local computing hardware of the mobile computing device capturing the video. For example, a neural network may execute using a graphics processing unit or other such parallel computing hardware of the mobile computing device.

A neural network may be comprised of a plurality of neural network nodes, where each node includes input values, a set of weights, and an activation function. The neural network node may calculate the activation function on the input values to produce an output value. The activation function may be a non-linear function computed on the weighted sum of the input values plus an optional constant. In some embodiments, the activation function is logistic, sigmoid, or a hyperbolic tangent function. Neural network nodes may be connected to each other such that the output of one node is the input of another node. Moreover, neural network nodes may be organized into layers, each layer comprising one or more nodes. An input layer may comprise the inputs to the neural network and an output layer may comprise the output of the neural network. A neural network may be trained and update its internal parameters, which comprise the weights of each neural network node, by using backpropagation.

A convolutional neural network may include one or more convolutional filters, also known as kernels, that operate on the outputs of the neural network layer that precede it and produce an output to be consumed by the neural network layer subsequent to it. A convolutional filter may have a window in which it operates. The window may be spatially local. A node of the preceding layer may be connected to a node in the current layer if the node of the preceding layer is within the window. If it is not within the window, then it is not connected. A convolutional neural network is one kind of locally connected neural network, which is a neural network where neural network nodes are connected to nodes of a preceding layer that are within a spatially local area. Moreover, a convolutional neural network is one kind of sparsely connected neural network, which is a neural network where most of the nodes of each hidden layer are connected to fewer than half of the nodes in the subsequent layer.

A recurrent neural network (RNN) may be used in some embodiments and is one kind of neural network and machine learning model. A recurrent neural network includes at least one back loop, where the output of at least one neural network node is input into a neural network node of a prior layer. The recurrent neural network maintains state between iterations, such as in the form of a tensor. The state is updated at each iteration, and the state tensor is passed as input to the recurrent neural network at the new iteration.

In some embodiments, the recurrent neural network is a long short-term (LSTM) memory neural network. In some embodiments, the recurrent neural network is a bi-directional LSTM neural network.

A feed forward neural network is another type of a neural network and has no back loops. In some embodiments, a feed forward neural network may be densely connected, meaning that most of the neural network nodes in each layer are connected to most of the neural network nodes in the subsequent layer. In some embodiments, the feed forward neural network is a fully-connected neural network, where each of the neural network nodes is connected to each neural network node in the subsequent layer.

Neural networks of different types or the same type may be linked together into a sequential or parallel series of neural networks, where subsequent neural networks accept as input the output of one or more preceding neural networks. The combination of multiple neural networks may comprise a single neural network and may be trained from end-to-end using backpropagation from the last neural network through the first neural network.

In some embodiments, the output of a classifier at step 202 may include a set of bounding boxes for a frame of video and a list of predicted categories of the items or objects within each bounding box, ranked by a predicted probability. For example, an image may include a refrigerator appliance and a microwave appliance. Each appliance would be identified by a bounding box corresponding to the pixels of the frame of video data that the item appears in. In addition, each bounding box may have an associated list of predicted categories of the item within the bounding box. For example, for a refrigerator appliance, a relatively high confidence may be predicted for the category of ‘refrigerator.’ Confidence may be expressed as a probability between 0 and 1, where the sum total of all probabilities sum to 1. For example, an image of a refrigerator may have a predicted classification of ‘refrigerator’ with a 0.7 confidence, and a predicted classification of ‘door’ with a 0.3 confidence.

Next, at step 203, the output of the classifier of step 202 may be filtered or augmented in real-time as each frame of video is processed. For example, in some embodiments, a minimal confidence threshold may be used to cull predictions lower than a threshold. For example, if a minimum confidence threshold of 0.4 is applied to the example above, the predicted classification of ‘door’ may be removed. If no prediction for an item remains after thresholding, the item may be discarded. In some embodiments, a running list of items or objects may be maintained as subsequent video frames are processed. Any items having a predicted classification above the threshold may be added to the list. In some embodiments, duplicates may not be added to the list. For example, if a refrigerator has already been imaged and returns to the refrigerator at a later point in the video capture process, even though a refrigerator is identified and classified with a high enough confidence in the later frames it may be omitted from the running list to avoid redundant entries.

At step 204, the video capture process concludes. For example, the mobile computing device receive a ‘stop’ instruction. At step 205, the mobile computing device recalls the list of the items segmented and classified during the video capture. Next, at step 206, the list of potential items is displayed by the mobile computing device for verification. In an embodiment, a representative image of each item is displayed along with a determined classification of the item. At step 207, the mobile computing device may receive input indicating an instruction to remove items from the list. In this step, the classification of an item may also be modified. In some embodiments, a mobile computing device may display a list of potential classifications to choose from including the alternative classification predications from the classifier of step 202. In some embodiments, a classification may be received from a user input device for an item. In some embodiments, any corrections or modifications of the predicted classifications at this step may be used to further train the classifier of step 202.

Next, at step 208, the mobile computing device receives an indication that the list is complete and accurate, and the mobile computing device proceeds to step 209, where an estimated value of each item is determined and associated with each item. In some embodiments, the estimated value may be retrieved from a local or remote database of values for items that represent a median or mean value of each category of item. At step 210, the mobile computing device may receive modifications to the value of items in the list. In some embodiments, the updated values for items may be transmitted to the value database for consideration in further refining the default values for items. In addition, at step 210, the mobile computing device may receive updated or modified quantities associated with an item in the list.

At step 211, the mobile computing device determines a location of the mobile computing device to associate with the items. For example, a latitude and longitude coordinate or street address may be determined or received that indicates the location of the mobile computing device at the time the video was captured. This information may be used to establish the location of the items at the time they were imaged in the video for insurance purposes later on.

At step 212, the video and the list of items along with each item's image, classification, and value estimation is transmitted from the mobile computing device to an insurance broker system. In step 212, the mobile computing device may also receive additional information that is used in the insurance underwriting process. For example, identifying information, financial information, and other such information may be received and transmitted along with the identification of items to the insurance broker system.

The insurance broker system, at step 213, receives the information transmitted from the mobile computing device in step 212 and determines one or more potential insurance policy quotes for the list of items. In some embodiments, this process may involve forwarding at least a portion of the information received in step 212 to one or more insurance underwriters and receiving quotes for insurance from the insurance underwriters. At step 214, any insurance quotes determined in step 213 are transmitted to the mobile computing device or other computing device. If an insurance quote is selected, the mobile computing device may receive an indication of the selected insurance quote and transmit the selection at step 215 to the insurance broker system and/or the insurance underwriter. In some implementations, the insurance broker system may issue an insurance policy based on the selection, and in other implementations further communications are initiated to issue an insurance policy.

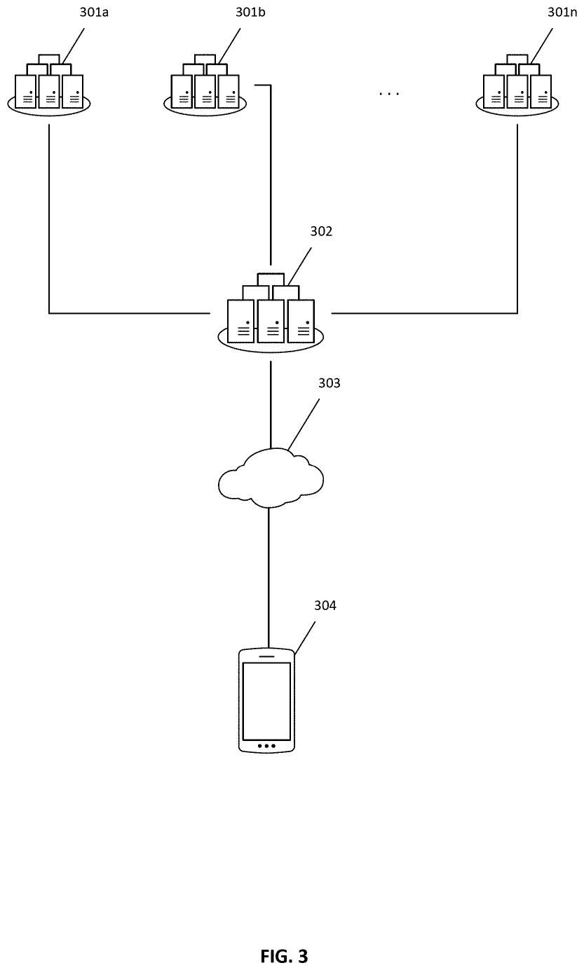

FIG. 3 illustrates an example computing environment according to an embodiment within which some methods described herein may operate. Mobile computing 304 device may be any kind of mobile computing device such as a smartphone device, a mobile phone, a digital camera, a tablet computer, a personal digital assistant, a laptop computer, or any other such mobile computing devices capable of capturing video. Mobile computing device 304 communicates with insurance broker system 302 via network 303. In turn, insurance broker 302 communicates with insurance underwriters 301a-301n.

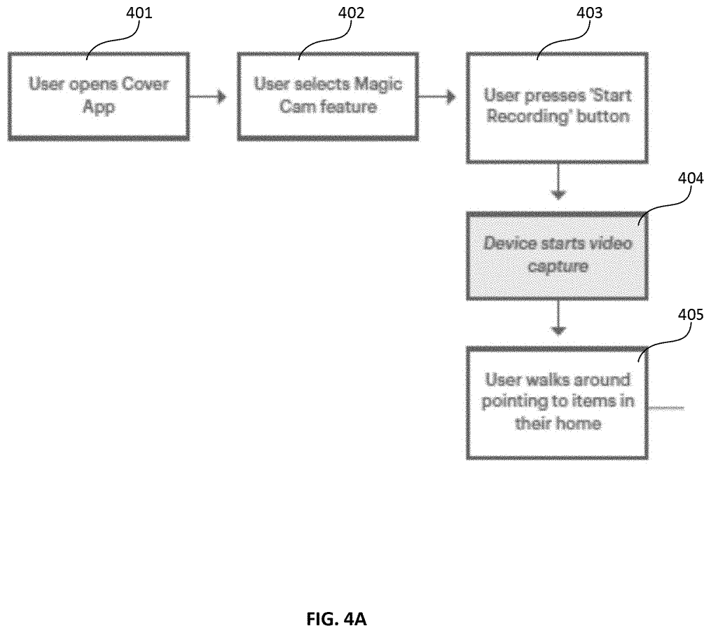

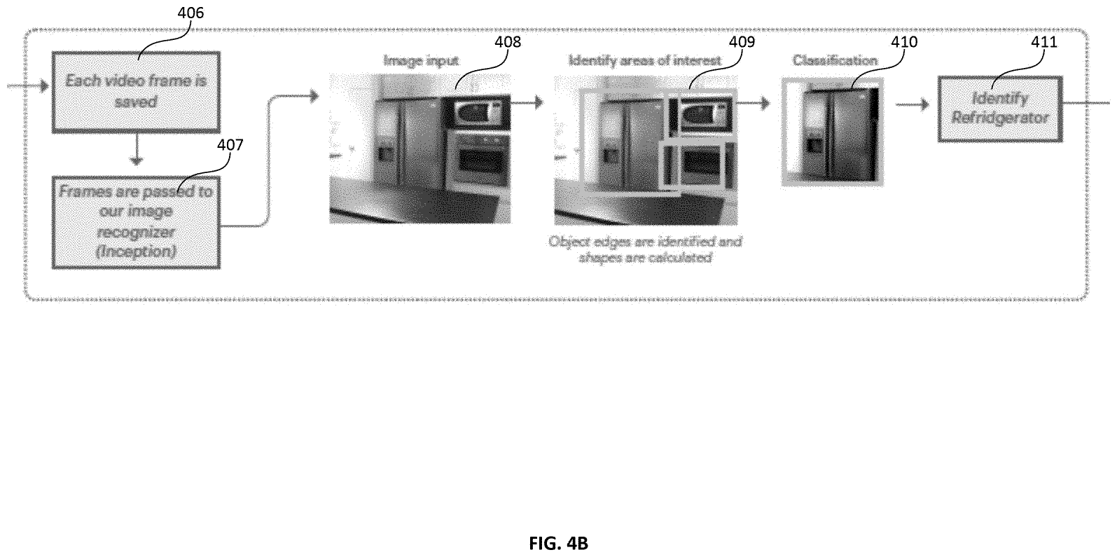

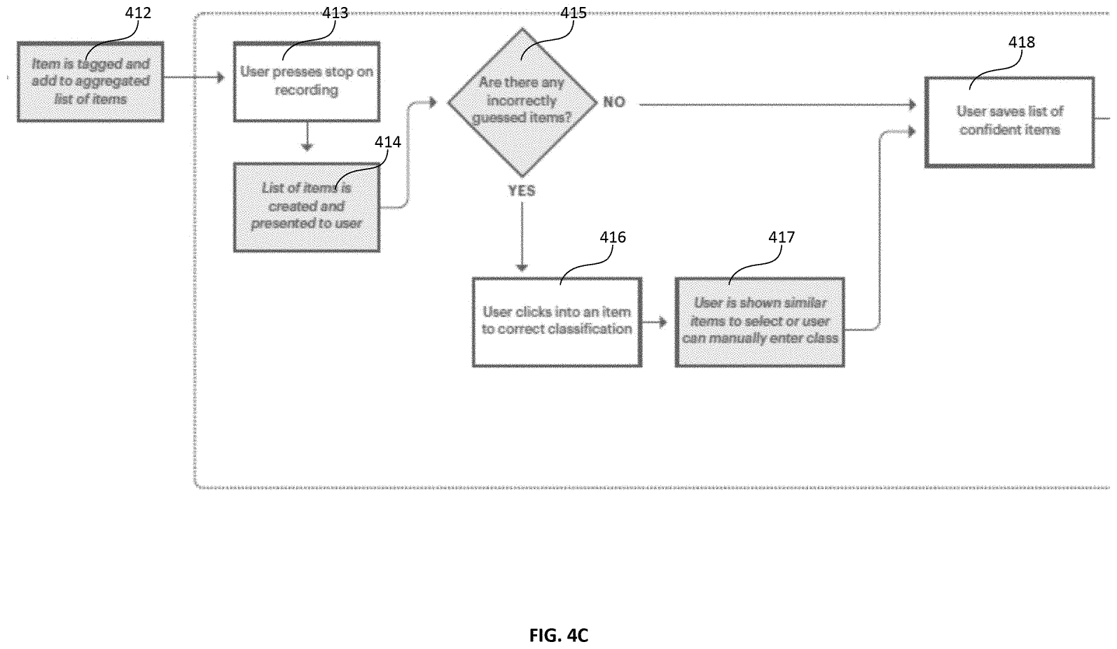

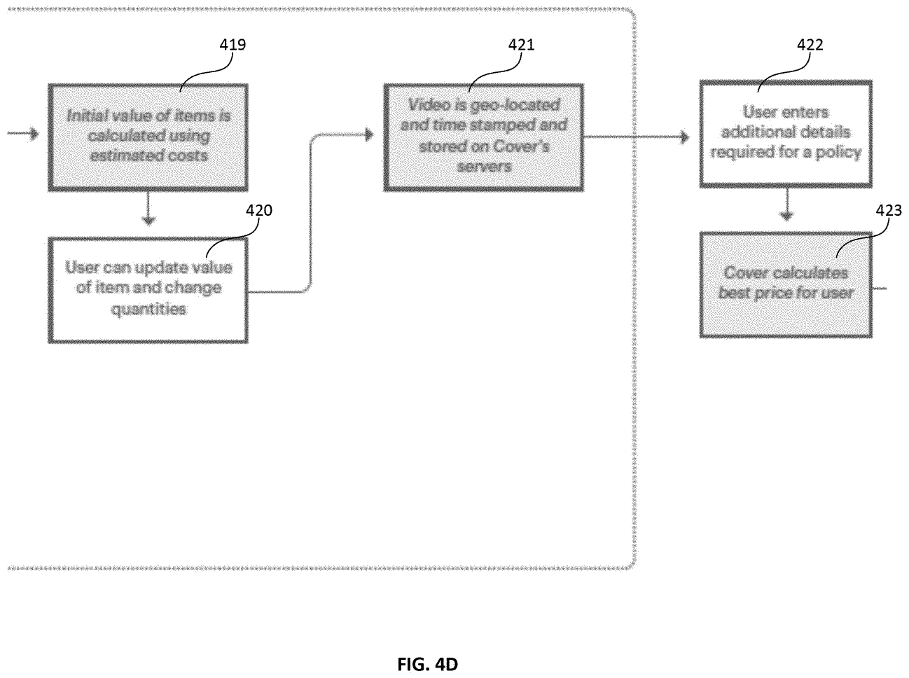

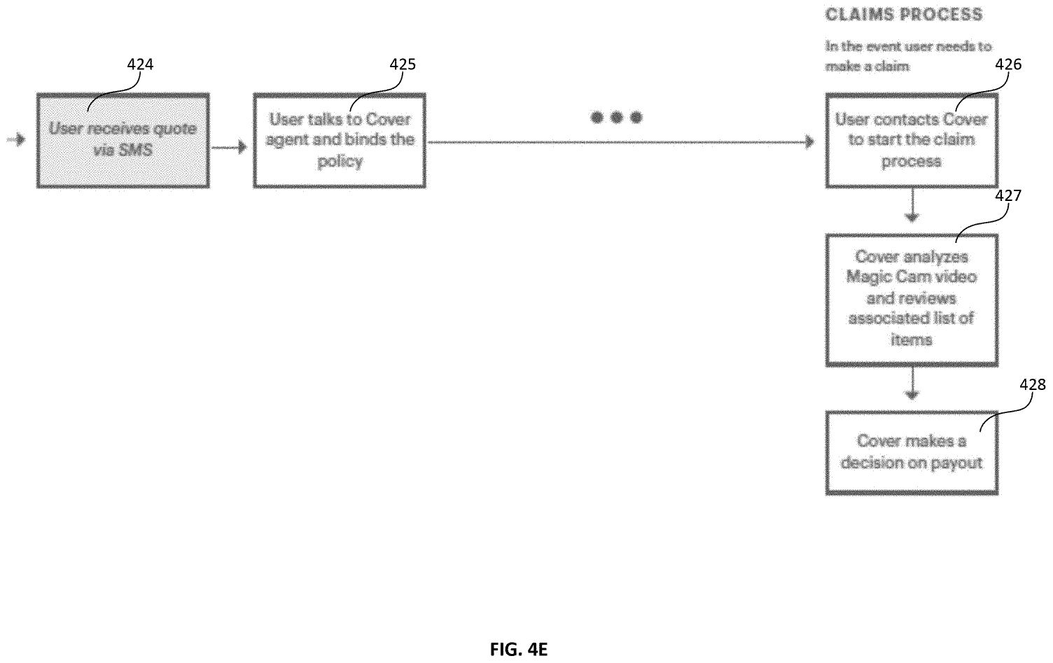

FIGS. 4A-4E illustrate a method of cataloging items according to an embodiment. At step 401, a mobile computing device initiates execution of instructions for an application for cataloging items. At step 402, a feature of the application for cataloging and classifying items is activated. At step 403, a video recording process is initiated, and at step 404, the mobile computing device begins recording video. The mobile computing device records video of various items in step 405 as a user walks around their home pointing the device at various items. The mobile computing device may prompt the user to point the device at items to insure them. Each frame of video is saved at step 406 and processed by an image recognizer at step 407. As an example, image 408 illustrates an image of scene containing multiple items. In example image 409, three bounding boxes represent portions of image 408 corresponding to three different potential items. For example, example image 410 illustrates the contents of a bounding box corresponding to a refrigerator.

At step 411, the refrigerator of example image 410 is recognized by the image recognizer. At step 412, image of the item identified in step 411 is tagged and added to an aggregated list of items recognized during the video capture. The process of capturing frames and recognizing items is repeated until step 413 where the video capture process concludes. The aggregated list of items is then presented on a display of the mobile computing device along with their classifications at step 414. At step 415, the mobile computing device may receive input indicating an incorrectly recognized image or item and may receive indication of a particular incorrectly recognized item at step 416. At step 417, the mobile computing device may present a list of potential corrections that may more accurately represent the item. The mobile computing device may receive a user input indicating a corrected classification of the item and may store the corrected classification, replacing the incorrect classification. The user input may be received as a selection, text input, or other input.

At step 418, the mobile computing device receives an input indicating that the aggregated list is correct and complete. Next, each item in the aggregated list of items is associated with an initial value estimate at step 419. The value estimate of each item is calculated based on the classification of the item. The value estimate may also be calculated based on features of the image captured of the item. At step 420, the initial value estimates for each item in the aggregated list is displayed by the mobile computing device, and the mobile computing device may receive input indicating a correction to one or more estimated initial values. After the list of estimated initial values is finalized, the mobile computing device determines its location at step 421 and the location is associated with the video that was captured.

At step 422, the mobile computing device may receive additional input of data to be associated with the video. Next, the video and the aggregated list of items is transmitted to an item cataloging server at step 423, and the item cataloging server transmits a response to the mobile computing device at step 424. The mobile computing device may initiate a communication with an agent of the item cataloging server at step 425. At a later time, if the video evidence gathered in previous steps is required to be reviewed at step 426, the item cataloging server may retrieve the video and the aggregated list of items associated with the video at step 427. Then, at step 428, the video and aggregated list of items may be reviewed and analyzed by a human reviewer or a machine learning model to make a determination on paying the claim. The machine learning model may be trained on previous decisions on insurance payouts. The machine learning model may be, for example, a neural network, transformer model using attention, logistic regression or classification, random forest, or other model.

In some embodiments, the machine learning model analyzes a plurality of features to determine whether to pay out the claim. In addition to the video and list of items, the machine learning model may also accept as input the current location of the user or the items that the claim is based on and information about the user, such as their credit history, credit score, or prior purchase history such as from a credit card. The machine learning model may be trained to automatically accept or deny claims based on these features in combination with the video and list of items.

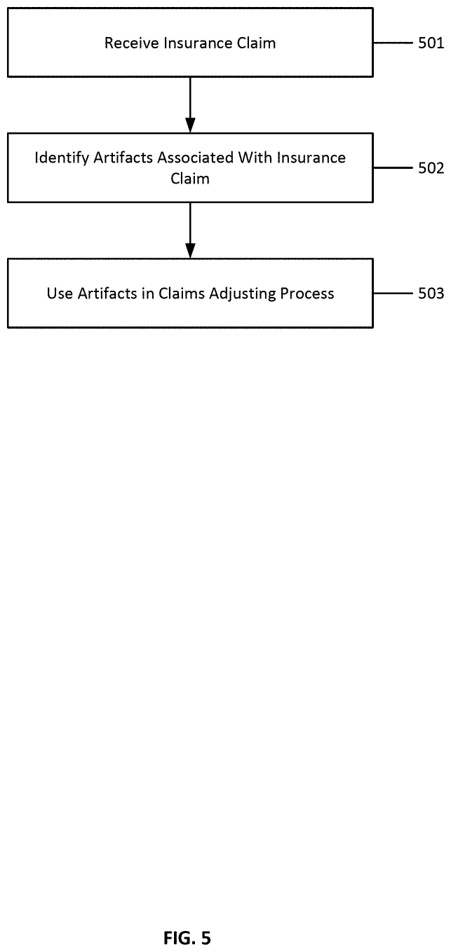

FIG. 5 illustrates the steps of a method for claims processing according to an embodiment. In some embodiments, the images, video, and other artifacts generated in the process of insurance underwriting may be used in claims processing. At step 501, an insurance claim is received. At step 502, the insurance claim is matched with the artifacts record at or around the time the insurance policy associated with the claim was issued. The artifact record may include the video captured during underwriting, the list of items generated during underwriting, the values of items received during underwriting, the location of the mobile computing device used to catalog the items during underwriting, or any other information captured or received during underwriting.

At step 503, claims adjusters may review the various artifacts identified in step 502 to evaluate the insurance claim. For example, the identity and state of any item may be reviewed in the images or video captured during underwriting and compared with the identity and state of any items that are a part of the insurance claim. In another example, the location of items at or around the time of underwriting may be reviewed and compared with the location of items that are a part of the insurance claim. If an item is not at the same location as it was when the insurance policy was issued, an insurance claims adjuster may use that information as a part of the insurance claims adjusting process. Similarly, if an item is damaged at the time of underwriting the insurance, as evident through video and/or image documentation captured during the insurance underwriting process, a claims adjusted may use that information as a part of the insurance claims adjusting process as well. The claims adjusters in step 503 may be implemented by a machine learning model, as described in step 428.

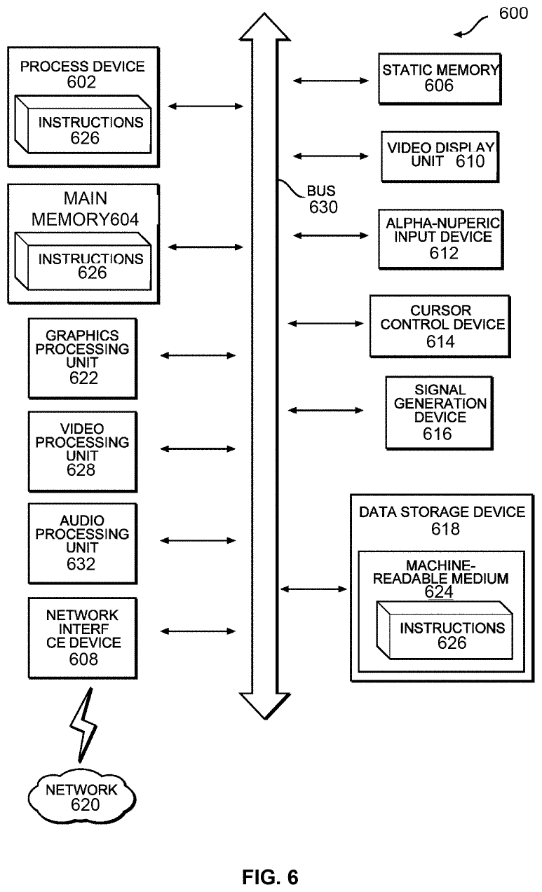

FIG. 6 illustrates an example machine of a computer system within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage device 618, which communicate with each other via a bus 630.

Processing device 602 represents one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein.

The computer system 600 may further include a network interface device 608 to communicate over the network 620. The computer system 600 also may include a video display unit 610 (e.g., a liquid crystal display (LCD) or a cathode ray tube (CRT)), an alphanumeric input device 612 (e.g., a keyboard), a cursor control device 615 (e.g., a mouse), a graphics processing unit 622, a signal generation device 616 (e.g., a speaker), graphics processing unit 622, video processing unit 628, and audio processing unit 632.

The data storage device 618 may include a machine-readable storage medium 624 (also known as a computer-readable medium) on which is stored one or more sets of instructions or software 626 embodying any one or more of the methodologies or functions described herein. The instructions 626 may also reside, completely or at least partially, within the main memory 604 and/or within the processing device 602 during execution thereof by the computer system 600, the main memory 604 and the processing device 602 also constituting machine-readable storage media.

In one implementation, the instructions 626 include instructions to implement functionality corresponding to the components of a device to perform the disclosure herein. While the machine-readable storage medium 624 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description below. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

A number of embodiments have been described. Nevertheless, it will be understood that various modifications may be made without departing from the spirit and scope of the invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A method for applied artificial intelligence object detection, comprising:
capturing, with a mobile computing device, an image of an item;
identifying, by a neural network, a classification of the item, the neural network including a plurality of convolutional filters;
recording a location of the mobile computing device;
associating the location of the mobile computing device with the image of the item; and
transmitting, from the mobile computing device and to a computing platform, the image of the item, the classification of the item, and the location of the mobile computing device,
wherein transmitting, from the mobile computing device and to the computing platform, the image of the item, the classification of the item, and the location of the mobile computing device causes the computing platform to store the image of the item, the classification of the item, and the location of the mobile computing device in a database and determine a parameter of an insurance policy based at least in part on the image of the item, the classification of the item, or the location of the mobile computing device.

2. The method of claim 1, wherein the image of the item is a frame of a video, and wherein the video comprises a plurality of frames of video.

3. The method of claim 2, further comprising:
identifying a classification of a plurality of items in the plurality of frames of video.

4. The method of claim 3, further comprising:
recording a timestamp of each frame of the video containing an item.

5. The method of claim 4, further comprising:
transmitting the classification of the plurality of items and the video to the computing platform.

6. The method of claim 1, wherein the identifying, by the mobile computing device and based on the image of the item, a classification of the item comprises:
transmitting the image of the item to an image recognition server; and
receiving, by the mobile computing device and from the image recognition server, a classification of the item.

7. The method of claim 1, wherein the identifying, by the mobile computing device and based on the image of the item, a classification of the item comprises:
processing, by the mobile computing device, the image of the item with a neural network, the neural network trained to classify images of items.

8. A non-transitory computer-readable medium containing instructions for cataloging items, the non-transitory computer-readable medium comprising instructions for:
capturing, with a mobile computing device, an image of an item;
identifying, by the mobile computing device and based on the image of the item, a classification of the item;
recording a location of the mobile computing device;
associating the location of the mobile computing device with the image of the item; and
transmitting, from the mobile computing device and to an insurance underwriting platform, the image of the item, the classification of the item, and the location of the mobile computing device,
wherein transmitting, from the mobile computing device and to the insurance underwriting platform, the image of the item, the classification of the item, and the location of the mobile computing device causes the insurance underwriting platform to store the image of the item, the classification of the item, and the location of the mobile computing device in a database and determine a parameter of an insurance policy based at least in part on the image of the item, the classification of the item, or the location of the mobile computing device.

9. The non-transitory computer-readable medium of claim 8, wherein the image of the item is a frame of a video, and wherein the video comprises a plurality of frames of video.

10. The non-transitory computer-readable medium containing instructions for cataloging items for insurance purposes of claim 9, wherein the non-transitory computer-readable medium further comprises instructions for:
identifying a classification of a plurality of items in the plurality of frames of video.

11. The non-transitory computer-readable medium containing instructions for cataloging items for insurance purposes of claim 10, wherein the non-transitory computer-readable medium further comprises instructions for:
recording a timestamp of each frame of the video containing an item.

12. The non-transitory computer-readable medium containing instructions for cataloging items for insurance purposes of claim 11, wherein the non-transitory computer-readable medium further comprises instructions for:
transmitting the classification of the plurality of items and the video to the insurance underwriting platform.

13. The non-transitory computer-readable medium of claim 8, wherein the identifying, by the mobile computing device and based on the image of the item, a classification of the item comprises:
transmitting the image of the item to an image recognition server; and
receiving, by the mobile computing device and from the image recognition server, a classification of the item.

14. The non-transitory computer-readable medium of claim 8, wherein the identifying, by the mobile computing device and based on the image of the item, a classification of the item comprises:
processing, by the mobile computing device, the image of the item with a neural network, the neural network trained to classify images of items.

15. A method, comprising:
receiving, from a mobile computing device, a video containing a plurality of frames depicting a plurality of items, each item tagged with a classification and a timestamp of when the item appears in the video;
retrieving, from a valuation database, an estimated valuation of each of the plurality of items;
tallying a total valuation of the plurality of items;
receiving additional information from the mobile computing device;
transmitting the total valuation of the plurality of items and the additional information to an insurance underwriting platform;
receiving, from the insurance underwriting platform, a plurality of insurance quotes for the plurality of items; and
transmitting the plurality of insurance quotes for the plurality of items to the mobile computing device.

16. The method of claim 15, wherein the additional information includes an indication of a location of the plurality of items.

17. The method of claim 16, further comprising:
receiving, from the mobile computing device, a location of the mobile computing device when the video was captured by the mobile computing device; and
comparing the location of the mobile computing device with the indication of a location of the plurality of items.

18. The method of claim 15, further comprising:
receiving an indication of an insurance claim from an insurance provider for at least one of the plurality of items; and
in response to receiving the indication of the insurance claim from the insurance provider for at least one of the plurality of items, transmitting the video containing frames depicting the plurality of items to the insurance provider.

19. The method of claim 15, further comprising:
transmitting the estimated valuation of each of the plurality of items to the mobile computing device;
receiving, the mobile computing device, adjustments to one or more of the estimated valuations; and
adjusting the total valuation of the plurality of items based on the adjustments to one or more of the estimated valuations.

20. The method of claim 15, further comprising:
receiving, from the mobile computing device, an indication of an insurance quote of the plurality of insurance quotes; and
associating the video containing frames depicting the plurality of items with the insurance quote.
